(19) United States
(12) Patent Application Publication
(10) Pub. No.: US 2008/0299445 A1
(43) Pub. Date: Dec. 4, 2008

(54) SECONDARY BATTERY PACK

(75) Inventors: Yasuo Nagasawa, Tokyo (JP); Hiroyuki Yashiro, Tokyo (JP); Kazuhiko Nakane, Tokyo (JP); Hiroshi Nakazawa, Tokyo (JP)

Correspondence Address: DARBY & DARBY P.C., P.O. BOX 770, Church Street Station, New York, NY, 10008-0770, US

(73) Assignee: DENSEI-LAMBDA K.K., Tokyo (JP)

(21) Appl. No.: 11/756,156

(22) Filed: May 31, 2007

(51) Int. Cl. H01M 2/12; H01M 10/02

(52) U.S. Cl. 429/86

(57) ABSTRACT

A chargeable and dischargeable lithium cell and the filter unit capable of absorbing flammable materials are housed inside a casing. When an overvoltage is impressed from a battery charger to a battery pack and then internal gases inside the lithium cell are discharged out of an explosion-proof valve, the flammable materials included in internal gases are absorbed by the filter unit to change the internal gases into nonflammable gases. The internal gases purified by passing through the filter unit are exhausted from a gas-vent opening to the outside of the casing. By providing the filter unit inside the casing, the flammable materials discharged out of the lithium cell 1 can be prevented from leaking to the outside of the casing.

### CROSS-REFERENCE TO RELATED APPLICATION

The present application is related to Japanese Patent Application No. 2005-042116 filed on Feb. 18, 2005. The content of the application is incorporated herein by reference in its entirety.

### FIELD

The present invention relates to a secondary battery pack equipped with a chargeable and dischargeable battery body such as a lithium-ion battery or the like.

### BACKGROUND OF THE INVENTION

Heretofore, a lead storage battery had been generally employed as a secondary battery. Recently, however, a lithium-ion battery which has extremely high power density and can be downsized has been extensively employed. In FIG. 5, a structure of a laminate-type lithium-ion battery is shown which is one type of the lithium-ion battery. A lithium cell 1 for acting as the laminate-type lithium-ion battery has a structure where an insulating separator 4 is inserted into a portion between a positive-electrode material 2 such as, e.g., cobaltate lithium (LiCoO₂), manganesate lithium (LiMnO₂) or the like and a negative-electrode material 3 such as, e.g., graphite (carbon) or the like and then some of this assembled unit are stacked into a layered structure 5, which is, together with an electrolyte, thereafter sealed with aluminum laminates 6, 6 from upper and lower sides thereof. The positive-electrode material 2 and the negative-electrode material 3 are each formed with a positive electrode 2a and a negative electrode 3a, respectively and both the electrodes protrude outside from bonded portions of the aluminum laminates 6, 6. In addition, how to protrude the electrodes, a figure and material of the electrodes, a size of the whole of the laminate battery or the like are not particularly limited to allow various types.

Regardless of the extremely high power density as an electricity storage medium, the lithium-cell 1 with the foregoing structure stands up poorly to an overvoltage and therefore application of an excessive overvoltage to the lithium cell in charging causes risks leading to smoking and kindling.

Hereunder, a mechanism in which the lithium-cell 1 leads to the smoking and the kindling in the application of the excessive charging voltage is described with reference to FIG. 6 for illustrating a state of the lithium-cell 1 for temperature.

First, when an overvoltage has been applied, degradation of the electrolyte inside the battery accelerates and then heat is generated to start temperature rise. At the same time, evaporating gases (diethyl carbonate and ethylene carbonate gases) of the electrolyte are generated inside the battery to cause expansion of the aluminum laminates 6, 6 to occur. On this occasion, in cases where an explosion-proof valve is provided as a discharging outlet for specifying a discharging direction of internal gases, as disclosed by Japanese unexamined patent application publication No. 11-283599, when pressure inside the battery has risen beyond a given value, the gases inside the battery are discharged from the explosion-proof valve to the outside of the battery to prevent explosion by this discharge of the gases. The separator 4 of the present battery has a double structure and its material is formed from PE (polyethylene) and PP (polypropylene). When an internal temperature of the battery has risen to reach about 120° C., the inside separator 4 begins to shrink. When the temperature has risen further, a PE separator for making up the separator 4 begins to dissolve at about 135° C. Then, the other PP separator begins to dissolve at 165° C. At this dissolution of the PP separator, an internal insulation breakdown of the lithium cell 1 progresses. Besides, seals of the aluminum laminates 6, 6 break to start discharge of the internal gases. Thence, when the temperature rise rapidly progresses to generate a thermal decomposition of the electrolyte at 250° C., gases such as CH₄, C₂H₄, C₂H₆ are generated to break the insulation performance of the separator 4. In due time, when short-circuiting has began, a sparking phenomenon acts as a kindling point, thus ending up the kindling.

As described above, the lithium cell 1 stands up poorly to an overvoltage due to use of a lithium ion and therefore it has been well-known that the application of the overvoltage led to the smoking and the kindling if the worst came to the worst. The detailed context has been, however, unexplained in which how much amount of energy including impressed voltages and currents caused the smoking and kindling of the laminate type lithium-ion battery and therefore a situation where no fundamental measure could be taken against the hazard has continued. With that, as an interim measure to solve the safety hazard, a protection circuit for preventing the smoking and kindling of the battery (e.g., refer to Japanese unexamined patent application publication No. 8-222278) is installed ordinarily inside a battery charger and a battery pack. In Japanese unexamined patent application publication No. 11-283599, when a flammable gas or the like has been detected, the smoking and kindling of the battery are prevented by prohibiting charging to a secondary battery.

### SUMMARY OF INVENTION

When the protection circuit fails to operate properly from any cause, however, risks of smoking and kindling cannot be avoided. Hence, the wide use of the lithium-ion battery for fields, where high reliability is required, such as an electric power source and an uninterruptible power supply unit has lagged behind.

Under the existing circumstances, in a mechanism which leads to the smoking and the kindling as described above, for input energy (voltage and current stresses) such as an overvoltage and excessive charging, it has been yet unexplained how far the process in the mechanism progressed. As a result, both battery makers and device makers using the battery are under a situation where they cannot help relying upon the protection circuit against the smoking and the kindling. Incidentally, the protection circuit for monitoring and controlling the battery, however, becomes inoperative for protection if its monitors (a voltage monitor, a current monitor and a temperature monitor) are out of order, or its controller (its control circuit) for receiving signals from the monitor to control the signals received is out of order, or further protection elements (a shut-off switch, a fuse, semiconductor switches such as FFTs, bipolar transistors or the like) for receiving signals from the controller to operate are out of order. That is, if the worst comes to the worst, there is possibility to induce the smoking and the kindling.

With the view to the problems described above, it is an object of the present invention to provide a secondary battery pack whose smoking and kindling can be prevented from occurring even if contained substances are discharged out of the secondary battery.

A first aspect of the present invention is a secondary battery pack equipped with chargeable and dischargeable battery bodies and a filter unit which is installed outside the battery bodies and absorbs flammable materials included in the contained substances discharged out of the battery bodies.

Accordingly, even if the contained substances are discharged out of the battery bodies due to a failure of the protection circuit or the like, the flammable materials included in the contained substances is absorbed by the filter unit and hence the flammable materials can be prevented from outflowing to an area around the secondary battery pack, thus allowing smoking and kindling to be prevented.

A second aspect of the present invention is a battery pack equipped with chargeable and dischargeable battery bodies, a filter unit which is installed outside the battery bodies and absorbs flammable materials included in the contained substances discharged out of the battery bodies, and an outer hull member which covers the battery bodies and the filter unit and besides is provided with an exhaust outlet for exhausting outward the contained substances purified by passing through the filter unit.

Accordingly, even if the contained substances are discharged out of any portions of the battery bodies due to failure of a protection circuit or the like, the contained substances are first off confined inside the outer hull member by the outer hull member covering the battery bodies to be prevented from outflowing to the outside of the secondary battery pack. Then, the flammable materials included in the contained substances confined inside the outer hull member are absorbed by the filter unit without fail to exhaust only contained substances not including the flammable materials to the outside of the outer hull member. Hence, the flammable materials are restrained from outflowing to an area around the secondary battery pack, thus allowing smoking and kindling to be prevented.

A third aspect of the present invention is a battery pack in which the filter unit is provided in the vicinity of and opposite to a discharging outlet for specifying an discharging direction of the contained substances discharged out of the battery bodies.

Accordingly, by taking advantage of an impetus with which the contained substances discharge out of the discharging outlet, the contained substances are allowed to go into the filter unit and then pass through the same, so that the contained substances immediately after the discharge are rapidly purified, changing the contained substances discharged into nonflammable ones.

According to the first aspect of the present invention, a secondary battery pack can be provided in which the smoking and the kindling can be prevented from occurring with a simple structure even if the contained substances are discharged out of the battery bodies.

According to the second aspect of the present invention, a secondary battery pack can be provided in which even if the contained substances are discharged out of any portions of the battery bodies, the flammable materials is unfailingly removed from the contained substances inside the outer hull member to permit the flammable materials to be exhausted to the outside of the outer hull member, thus allowing the smoking and kindling of the secondary battery to be prevented from occurring with a simple structure.

According to the third aspect of the present invention, a secondary battery pack can be provided in which the contained substances immediately after the discharge are rapidly purified, thus allowing the smoking and kindling of the secondary battery from occurring.

### BRIEF DESCRIPTION OF THE DRAWING

The invention will be more readily understood by reference to the following description, taken with the accompanying drawings, in which:

FIG. 1 is a block diagram illustrating a structure of a secondary battery pack in an embodiment of the present invention.

FIG. 2 is a perspective view illustrating the structure of the secondary battery pack in the same.

FIG. 3 is a traverse sectional view of substantial parts illustrating the structure of the secondary battery pack in the same.

FIG. 4 is a longitudinal sectional view of the substantial parts illustrating the structure of the secondary battery pack in the same.

FIG. 5 is an exploded perspective view illustrating an internal structure of a laminate type lithium-ion battery.

FIG. 6 is an explanatory diagram illustrating a mechanism where a laminate type lithium-ion battery leads to smoking and kindling.

### DESCRIPTION OF THE PREFERRED EMBODIMENTS

The following is a detailed description of a preferred embodiment of a secondary battery pack according to the present invention with reference to the appended drawings. In addition, the same numeral symbols are labeled for parts the same as in a conventional example and descriptions of common parts are omitted to avoid an overlap in the description.

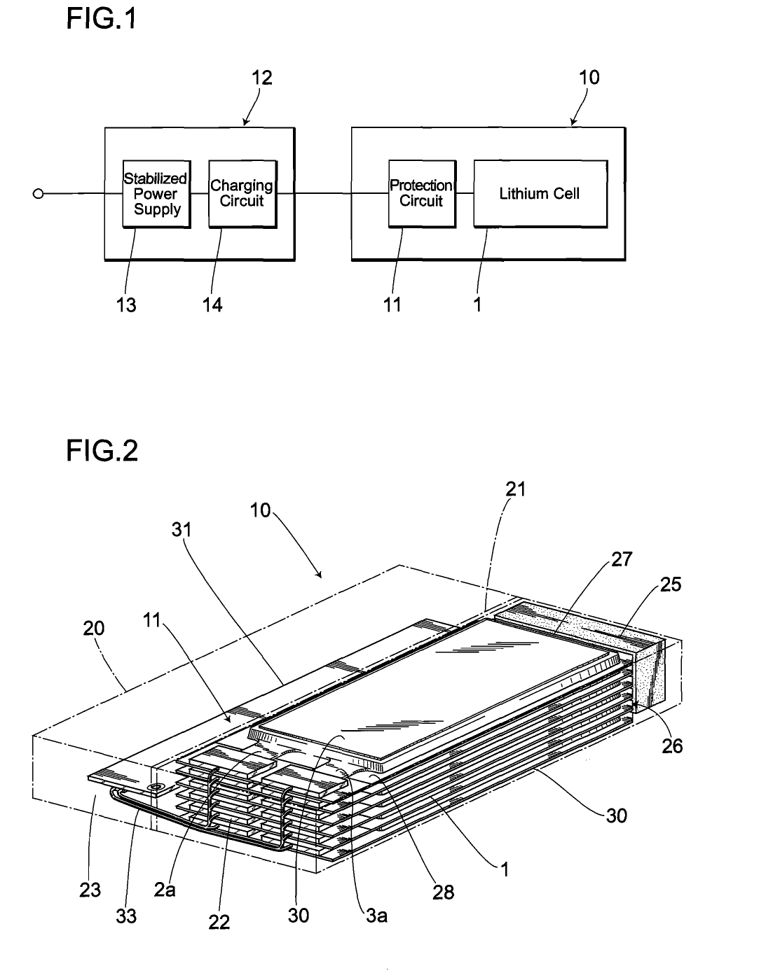

FIG. 1 is a block diagram representing an outline structure in the case of mounting a lithium cell 1 for acting as chargeable and dischargeable battery bodies on an electronic device or the like. In the figure, a battery pack 10 for acting as the secondary battery is incorporated with lithium cells 1 together with a protection circuit 11. The protection circuit 11 is equipped with, e.g., a current fuse, a temperature fuse, an overvoltage protector or the like to cut off charging power fed to the lithium cell 1 in occurrence of an overcurrent, an overvoltage and an abnormal temperature and Accordingly protects the lithium cell 1. A battery charger 12 for charging the lithium cell 1 by inputting electric power thereto is connected with a previous stage of the battery pack 10. The battery charger 12 comprises a stabilized power supply 13 for producing stabilized charging electric power and a charging circuit 14 for charging the lithium cell 1 using the stabilized charging electric power. The charging circuit 14 comprises constant-voltage and constant-current circuits for making a charging voltage or a charging current constant to charge linearly the lithium cell 1, a pulse charging circuit for supplying pulse-shaped charging currents to charge the lithium cell 1 by the pulse currents and so on. These circuits are set accordingly by performance and life span of a battery.

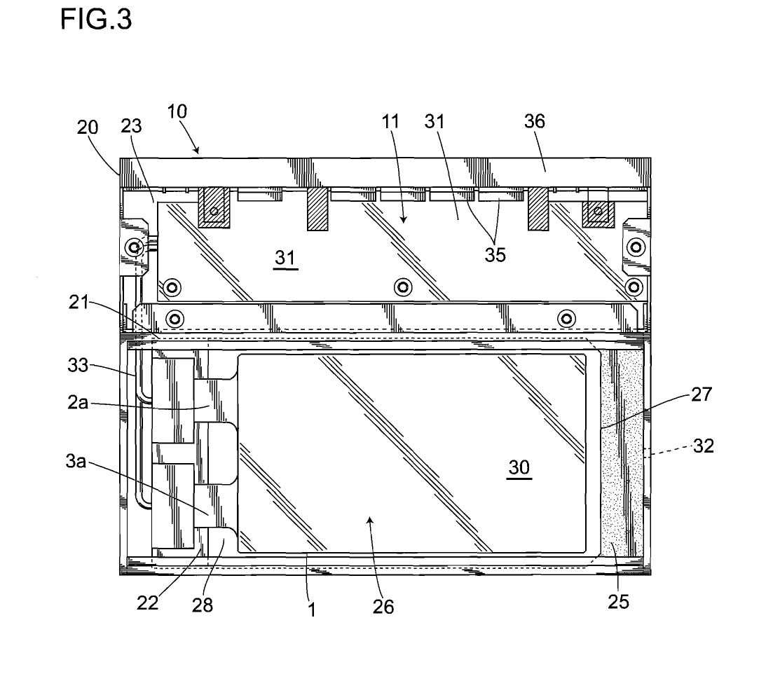

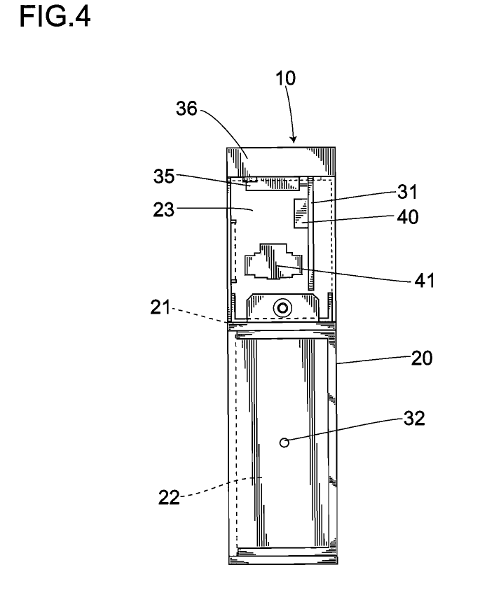

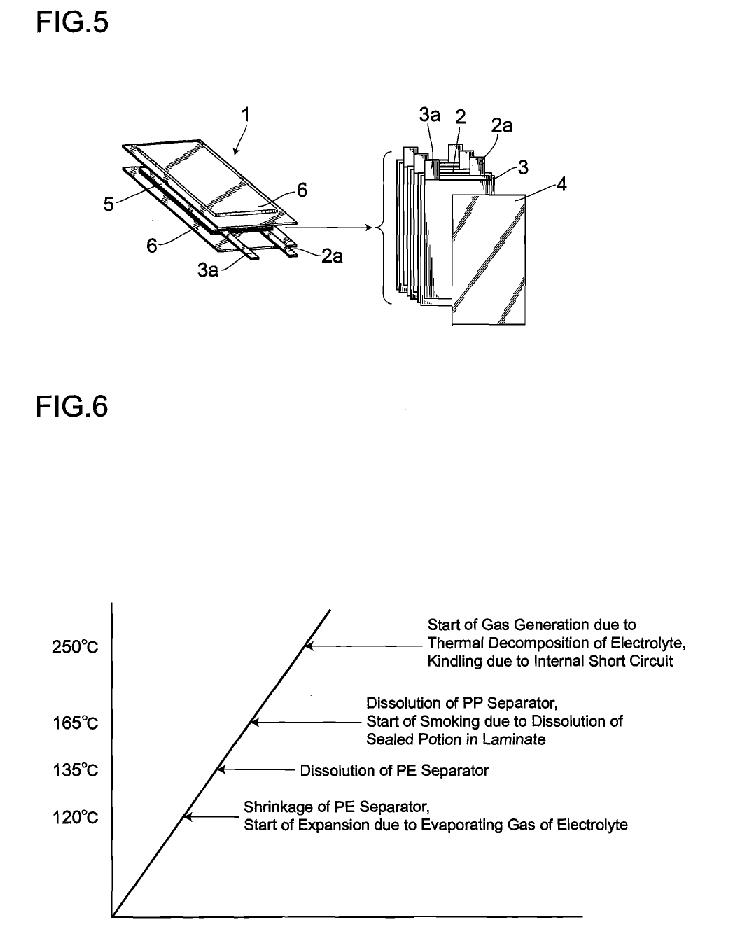

FIG. 2 is a perspective view representing an internal structure of the battery pack 10. FIG. 3, 4 are sectional views of substantial parts that represent a structure of the battery pack 10 and are viewed from lateral and longitudinal directions, respectively. The battery pack 10 is constituted by housing, inside a casing 20 for acting as an outer hull member, mainly a battery stack 26 comprising a plurality of the lithium cells 1 which are stacked together and are connected to one another, and a printed-circuit board 31 mounted with circuit parts of the protection circuit 11. The casing 20 is formed by making, into a boxy shape, an excellently exoergic member such as e.g., an aluminum material, while its internal space is partitioned into a battery chamber 22 and a circuit board chamber 23 by a partition board 21 formed nearly at its central portion. The battery stack 26 is housed in the battery chamber 22, while the printed-circuit board 31 is housed in the circuit board chamber 23 separately from the battery stack 26.

The battery stack 26 has a structure where a plurality of the lithium cells 1 is vertically stacked and excellently exoergic interlayer members 28 such as an aluminum plate or the like are interposed between each lithium cell 1. In the battery stack 26, heat is prone to remain in its central portion to provide tendency for lithium cells 1 located in a central portion of the battery stack 26 to result in higher temperature rise than temperatures of the other lithium cells located apart from the central portion. The heat generated in each lithium cell 1 is dissipated rapidly by providing the excellently exoergic interlayer members 28 between each lithium cell 1. Hence, the heat remains in no central portion of the battery stack 26, thus enabling the temperature rise of the lithium cell 1 to be prevented. The lithium cell 1 building up the battery stack 26 develops a tendency to lengthen in life span by exerting rather some degree of pressure on its surface due to the resulting good contact between electrodes and electrolyte. Hence, the battery pack 26 is sandwiched by heat dissipating plates 30, 30 from an upside and downside thereof to be fixed with appropriate pressure exerted by making the heat dissipating plates 30, 30 subjected to pressurized contact with the casing 20, thus being housed inside the battery chamber 22. The heat dissipating plates 30, 30 transfer the heat generated by the battery pack 26 in charging and discharging to the casing 20 to dissipate the heat, thereby constraining a temperature rise of each lithium cell 1. In addition, the lithium cell 1 in the present embodiment is provided with an explosion-proof valve 27 in an end opposite to a position in which a positive electrode 2a and a negative electrode 3a are provided. The positive electrode 2a and negative electrode 3a of the lithium cell 1, eventually of the battery stack 26 are connected electrically with the protection circuit 11 mounted on the printed-circuit board 31 by means of connecting cables 33 penetrating the partition board 21.

The battery chamber 22 houses a filter unit 25, other than the battery stack 26, close to the explosion-proof valve 27 of the lithium cell 1. The filter unit 25 is made up from, e.g., activated charcoal, an absorptive member corresponding to the former, a nanofiber filter threadline raw material which can absorb a volatile organic solvent, or the like. The filter unit 25 is made to absorb internal gases that are contained substances discharged out of the explosion-proof valve 27 in excessive charging or the like of the lithium cell 1, i.e., evaporating gases of the electrolyte led directly to the smoking and the kindling, and flammable materials included in volatile organic gases or the like. A gas-vent opening 32 for acting as an exhaust outlet is formed in a wall surface of the battery chamber 22 opposed to the filter unit 25.

The printed-circuit board 31 housed in the circuit board chamber 23 is fixed to the casing 20 by e.g., screwing. Exothermic parts 35 such as, e.g., MOSFETs or the like making up the protection circuit 11 are mounted on the printed-circuit board 31. The exothermic parts 35 are connected thermally with a heatsink 36 which forms a sidewall of the circuit board chamber 23 extending in a longitudinal direction of the casing 20. Although the heatsink 36 is formed from a thick flat-plate-like member in the figure, heat dissipating performance may be enhanced by arranging a plurality of fins or the like side by side in a line. On account of heat generation of the exothermic parts 35 in charging and discharging of the battery stack 26, the heat generated is schemed to be dissipated by the heatsink 36. On a wall surface of the circuit board chamber 23 which is perpendicular to the longitudinal direction of the heatsink 36 and extends in a narrow-side direction of the casing 20, an opening is formed for exposing a main connector 41 and a warning connector 40. The main connector 41 is connected electrically with the protection circuit 11 by being mounted on the printed-board circuit, e.g., using soldering or the like. A charging device 12 not shown is connected with the main connector 41 to Accordingly permit charging electric power for charging the battery pack 26 to be supplied to the battery pack 10. The warning connector 40 is provided to take out, from the protection circuit 11, warning signals which are output, e.g., at the time of charging electric power interruption or the like caused by protection of an overvoltage and excessive charging.

Next is a description of behavior at the time of an overvoltage and excessive charging of the battery pack 10.

When the overvoltage 10 has been applied from the battery charger 12 to the battery pack 10, dissolution of the electrolyte inside the lithium cell 1 accelerates to generate heat, so that a temperature rise of the lithium cell 1 starts. At the same time, the evaporating gases of the electrolyte are generated inside the lithium cell 1 to cause expansion of the aluminum laminates 6, 6. When a further increase of the temperature rise generates thermal decomposition of the electrolyte, volatile organic gases such as CH₄, C₂H₄, C₂H₆ or the like are generated. At this time, when pressure inside the lithium cell 1 has risen beyond a given value, the internal gases such as the evaporating gases of the electrolyte inside the lithium cell 1, the volatile organic gases or the like are discharged out of the explosion-proof valve 27. If no explosion-proof valve is provided and there exist defects such as an oppilation of the explosion-proof valve 27 or the like, seals of the aluminum laminates 6, 6 of the lithium cell 1 are broken, the internal gases discharge out of the broken portion. An internal space of the casing 20 covering the battery stack 26 is partitioned into the battery chamber 22 and the circuit board chamber 23 by the partition board 21 to separate both the chambers hermetically. Hence, no inflow of the internal gases occurs out of the battery chamber 22 where the battery stack 26 is housed to the circuit board chamber 23, thus making it possible to prevent the kindling initiated from the protection circuit 11 mounted on the printed-circuit board 31 and adverse effects on parts mounted on the printed-circuit board 31. Herewith, by housing the battery stack 26 in the battery chamber 22 formed in the casing 20, even if the internal gases discharge out of any portions of the lithium cell 1 due to the defects of the protection circuit 11 or the like, the internal gases are first off confined inside the battery chamber 22, eventually inside the casing 20 by means of the casing 20 covering the lithium cell 1, resulting in no leakage to the outside of the circuit board chamber 23 and battery pack 10.

The internal gases discharged out of the lithium cell 1 go into the filter unit 25 provided in the vicinity of the explosion-proof valve 27 and then the flammable materials included in the internal gases are absorbed by means of the filter unit 25 to be Accordingly purified, so that concentration of the flammable materials in the internal gases is lowered, thus changing the internal gases into nonflammable ones until the time the internal gases have finished passing through the filter unit 25. In the present embodiment, the filter unit 25 is provided opposite to and in the vicinity of the explosion-proof valve 27 so as to be positioned in a discharging direction of the internal gases. Whereby, the internal gases are made to go directly into and pass through the filter unit 25 by taking advantage of a discharging impetus of the internal gases out of the explosion-proof valve 27, so that the internal gases immediately after the discharge are rapidly purified, thus making it possible to change the internal gases into the nonflammable gases having no flammable material. The internal gases purified by passing through the filter 25 are exhausted finally from the gas-vent opening 32 to the outside of the casing 20 and hence there occurs no abnormal pressure rise inside the casing 20. In addition, when the purified substance that has passed through the filter 25 is liquid matter, the gas-vent opening 32 may be provided at a lower side or bottom of the battery pack to exhaust the liquid matter from the gas-vent opening 32. Thus, the flammable materials included in the internal gases discharged out of the lithium cell 1 are absorbed by providing the filter unit 25 in the battery pack 10 and hence the flammable materials can be prevented from leaking to the outside of the casing 20.

As described above, the battery pack 10 in the present embodiment is equipped with the lithium cell 1 for acting as the chargeable and dischargeable battery bodies and the filter unit 25 placed outside the lithium cell 1 to absorb the flammable materials included in the internal gases for acting as the contained substance discharged out of the lithium cell 1.

Accordingly, even if the internal gases are discharged out of the lithium cell 1 due to defects of the protection circuit 11 or the like, the flammable materials included in the internal gases are absorbed by the filter unit 25. Hence, the flammable materials can be prevented from outflowing to the area around the battery pack 10 to enable the smoking and the kindling to be prevented. Accordingly, the battery pack 10 can be provided in which even if the internal gases are discharged out of the lithium cell 1, the smoking and kindling of the lithium cell 1, eventually of the battery stack 26 can be prevented from occurring with the simple structure.

Further, the battery pack 10 in the present embodiment is equipped with the chargeable and dischargeable lithium cell 1, the filter unit 25 placed outside the lithium cell 1 to absorb the flammable materials included in the internal gases discharged out of the lithium cell 1, and the casing 20 for covering the lithium cell 1 and the filter unit 25 to act as the an outer hull provided with the gas-vent opening for acting as the exhaust outlet for exhausting, to the outside, the internal gases purified by passing through the filter unit 25.

Accordingly, even if the internal gases are discharged out of any portions of the lithium cell 1 due to defects of the protection circuit 11 or the like, the internal gases are first off confined inside the casing 20 by the casing 20 covering the lithium cell 1 to be prevented from leaking to the outside of the battery pack 10. Then, the flammable materials included in the internal gases confined inside the casing 20 are absorbed by the filter unit 25 without fail and further only the nonflammable gases that are the internal gases not including the flammable materials are discharged out of the gas-vent opening 32 provided in the casing 20 to the outside of the casing 20. Hence, the flammable materials can be blocked from outflowing to the area around the battery pack 10 to allow the smoking and the kindling to be prevented. Consequently, even if the internal gases are discharged out of any portions of the lithium cell 1, the flammable materials can be removed unfailingly from the internal gases inside the casing 20 to allow the flammable materials to be discharged to the outside of the casing 20. Hence, the battery pack 10 can be provided in which the smoking and kindling of the lithium cell 1, eventually of the battery stack 26 can be prevented from occurring with the simple structure.

Further, in the present embodiment, the filter unit 25 is provided in the vicinity of and opposite to the explosion-proof valve 27 for acting as the discharging outlet for specifying the discharging direction of the internal gases discharged out of the lithium cell 1.

Accordingly, the internal gases are made to go directly into and pass through the filter unit 25 by taking advantage of a discharging impetus of the internal gases out of the explosion-proof valve 27, so that the internal gases immediately after the discharge are rapidly purified, thus making it possible to change the internal gases into the nonflammable gases. Consequently, the battery pack 10 can be provided in which the internal gases immediately after the discharge are purified rapidly, thus allowing the smoking and kindling of the lithium cell 1, eventually of the battery stack 26 to be prevented from occurring.

In addition, the present invention is not limited to the embodiment described above and various modifications are possible within the scope of the gist of the present invention. A secondary battery to which the present invention is applicable is not limited to the lithium-ion battery and any batteries may be available as long as the batteries discharge contained substances such as internal gases or the like at the time of an overvoltage charging and excessive charging. In the case of secondary batteries which discharges aquiform contained substances at high temperature, the filter unit may be formed from, e.g., a sponge-like liquid absorption member to absorb the aquiform contained substances for preventing outflowing thereof. Furthermore, the filter unit 25 may be arranged so as to encompass the lithium cell 1, eventually of the battery stack 26 and may be mounted directly on the lithium cell 1.

What is claimed is:

1. A secondary battery pack comprising:
a chargeable and dischargeable battery body, and
a filter unit which is placed outside said battery body and absorbs flammable materials included in contained substances discharged out of said battery bodies.

2. A secondary battery pack comprising:
a chargeable and dischargeable battery bodies,
a filter unit which is placed outside said battery bodies and absorbs flammable materials included in contained substances discharged out of said battery bodies, and
an outer hull member which covers said battery bodies and said filter unit and is provided with an exhaust outlet for exhausting outside said contained substances purified by passing through said filter unit.

3. A secondary battery pack according to claim 2, wherein said exhaust outlet is provided in a lower part of said outer hull member.

4. A secondary battery pack according to claim 2, wherein said outer hull member is formed from an aluminum material.

5. A secondary battery pack according to claim 1, wherein said filter unit is provided in the vicinity of and opposite to a discharging outlet for specifying a discharging direction of said contained substances.

6. A secondary battery pack according to claim 5, wherein said filter unit is provided in the vicinity of and opposite to a discharging outlet for specifying a discharging direction of said contained substances.

7. A secondary battery pack according to claim 5, wherein said filter unit is formed from a liquid absorption member.

8. A secondary battery pack according to claim 5, wherein said filter unit is provided so as to surround a battery stack.

9. A secondary battery pack according to claim 5, wherein said filter unit is provided directly on said battery body.
